(19) United States
(12) Patent Application Publication
(10) Pub. No.: US 2013/0318302 A1
(43) Pub. Date: Nov. 28, 2013

(54) CACHE CONTROLLER BASED ON QUALITY OF SERVICE AND METHOD OF OPERATING THE SAME

(71) Applicant: SAMSUNG ELECTRONICS CO., LTD., Suwon-si (KR)

(72) Inventor: Moon-Gyung KIM, Hwaseong-si (KR)

(73) Assignee: SAMSUNG ELECTRONICS CO., LTD., Suwon-si (KR)

(21) Appl. No.: 13/828,992

(22) Filed: Mar. 14, 2013

(30) Foreign Application Priority Data
May 23, 2012 (KR) 10-2012-0054967

(51) Int. Cl. G06F 12/08

(52) U.S. Cl. CPC G06F 12/0891
USPC 711/122; 711/134

(57) ABSTRACT

A cache controller includes an entry list determination module and a cache replacement module. The entry list determination module is configured to receive a quality of service (QoS) value of a process, and output a replaceable entry list based on the received QoS value. The cache replacement module is configured to write data in an entry included in the replaceable entry list. The process is one of a plurality of processes, each having a QoS value, and the replaceable entry list is one of a plurality of replaceable entry lists, each including a plurality of entries and each corresponding to one of the QoS values. The number of total entries is allocated to processes based on the QoS values of the processes.

### CROSS-REFERENCE TO RELATED APPLICATION

This application claims priority under 35 U.S.C. §119(a) to Korean Patent Application No. 10-2012-0054967, filed on May 23, 2012, the disclosure of which is incorporated by reference herein in its entirety.

### TECHNICAL FIELD

Exemplary embodiments of the present inventive concept relate to a cache controller, and more particularly, to a quality of service (QoS) based cache controller which may increase a cache hit ratio based on QoS, and a method of operating the same.

### DISCUSSION OF THE RELATED ART

A cache is a memory device that temporarily stores data and instructions communicated between a central processing unit (CPU) and a memory device, e.g., a secondary memory device, which has a speed slower than that of the CPU. The cache may be a high speed memory device, and accessing data and instructions stored in the cache may be faster than accessing data and instructions stored in the secondary memory device.

When a CPU reads data from a secondary memory device or writes data in the secondary memory device, the data and an address of the secondary memory device, e.g., a physical address, are stored in a cache. When a CPU reads data, a cache controller attempts to find the data in the cache using the physical address of the data. When the data is stored in the cache, the cache controller outputs the data to the CPU. When the data is not stored in the cache, the cache controller reads the data from a secondary memory device, outputs the read data to the CPU, and stores the read data in the cache.

Accordingly, when data to be read is stored in a cache, a processor does not need to access a secondary memory device to read the data, and as a result, the processing speed of the data may be increased.

When a plurality of processes is executed in a processor, each of the plurality of processes shares a cache. When data stored in the cache is replaced by another process, a cache hit ratio may decrease, and a cache controller may have to read the data again from a secondary memory device when the data is accessed again.

When data stored in a cache by a process requiring a fast processing speed is replaced by a process requiring a relatively slower processing speed, the processing speed of the process requiring the faster processing speed may be decreased.

### SUMMARY

An exemplary embodiment of the present inventive concept is directed to a quality of service (QoS) based cache controller, including an entry list determination module configured to output a replaceable entry list based on a QoS value of a process, and a cache replacement module configured to write data in an entry included in the replaceable entry list.

The entry list determination module may include a QoS look-up table configured to store each of entry lists corresponding to each of QoS values, and a QoS value check module configured to receive the QoS value, read an entry list corresponding to a received QoS value among the entry lists from the QoS look-up table, and output a read entry list as the replaceable entry list. The QoS look-up table may be embodied in a register.

At least two of the entry lists may include at least one identical entry. Each of the entry lists may include a different entry. Each of the entry lists may include at least one cache index corresponding to each of the QoS values. Each of the entry lists may include at least one cache way corresponding to each of the QoS values.

The QoS based cache controller may be a level 1 (L1) cache controller or a level 2 (L2) cache controller.

An exemplary embodiment of the present inventive concept is directed to a processor, including a CPU core, a cache memory including the entries, and the QoS based cache controller.

An exemplary embodiment of the present inventive concept is directed to an electronic device, including the processor, and a display configured to display data processed by the processor.

An exemplary embodiment of the present inventive concept is directed to a method of operating a cache controller, including determining a replaceable entry list based on a quality of service (QoS) value of a process when a cache miss occurs, and writing data which the cache miss occurs in to an entry included in the replaceable entry list.

Determining the replaceable entry list may include reading the replaceable entry lists corresponding to the QoS value from a QoS look-up table which stores each of entry lists corresponding to each of QoS values.

Each of the entry lists may include at least one cache index corresponding to each of the QoS values. Each of the entry lists may include at least one cache way corresponding to each of the QoS values.

Writing the data may include comparing the number of currently allocated entries for the QoS value with the number of whole entries included in the replaceable entry list, writing the data in an entry among the whole entries except for the currently allocated entries when the number of the currently allocated entries is less than the number of the whole entries according to a result of the comparison, and replacing an entry among the currently allocated entries when the number of the currently allocated entries is not less than the number of the whole entries according to the result of the comparison.

An exemplary embodiment of the present inventive concept is directed to a method of operating a cache controller, including comparing the number of currently allocated entries for a QoS value of a process with the number of maximum allocatable entries for the QoS value when a cache miss occurs, allocating a new entry for the QoS value when the number of the currently allocated entries is less than the number of the maximum allocatable entries, and replacing one of the currently allocated entries when the number of the currently allocated entries is not less than the number of the maximum allocatable entries.

An exemplary embodiment of the present inventive concept is directed to a cache controller including an entry list determination module configured to receive a quality of service (QoS) value of a process, and output a replaceable entry list based on the received QoS value, and a cache replacement module configured to write data in an entry included in the replaceable entry list. The process is one of a plurality of processes, each having a QoS value, and the replaceable entry list is one of a plurality of replaceable entry lists, each including a plurality of entries and each corresponding to one of the QoS values. The number of total entries is allocated to processes of the plurality of processes based on the QoS values of the processes. A greater number of the total entries may be allocated to a first process of the plurality of processes having a first QoS value than to a second process of the plurality of processes having a second QoS value lower than the first QoS value.

An exemplary embodiment of the present inventive concept is directed to a cache controller including an entry list determination module comprising a quality of service (QoS) look-up table configured to store a plurality of replaceable entry lists. Each of the plurality of replaceable entry lists includes a plurality of entries and corresponds to a different QoS value, each QoS value corresponds to a different process, and a number of total entries is allocated to the processes based on the QoS values of the processes.

An exemplary embodiment of the present inventive concept is directed to method of operating a cache controller including searching for data in a cache, determining a replaceable entry list based on a received quality of service (QoS) value of a process upon an occurrence of a cache miss, and writing the data in an entry included in the replaceable entry list. The process is one of a plurality of processes, each having a QoS value, and the replaceable entry list is one of a plurality of replaceable entry lists, each including a plurality of entries and each corresponding to one of the QoS values. A number of total entries is allocated to processes of the plurality of processes based on the QoS values of the processes.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram of an electronic device according to an exemplary embodiment of the present inventive concept;

FIG. 2 is a block diagram of the processor illustrated in FIG. 1 according to an exemplary embodiment of the present inventive concept;

FIG. 3 is a block diagram of the cache controller illustrated in FIG. 2 according to an exemplary embodiment of the present inventive concept;

FIG. 4 is a block diagram of the entry list determination module illustrated in FIG. 3 according to an exemplary embodiment of the present inventive concept;

FIG. 5 is a conceptual diagram illustrating a method of setting an entry list corresponding to each of a plurality of QoS values according to an exemplary embodiment of the present inventive concept;

FIG. 6 is a conceptual diagram illustrating a method of setting an entry list corresponding to each of a plurality of QoS values according to an exemplary embodiment of the present inventive concept;

FIG. 7 is a flowchart illustrating a method of controlling a cache memory according to an exemplary embodiment of the present inventive concept;

FIG. 8 is a flowchart illustrating a method of controlling a cache memory according to an exemplary embodiment of the present inventive concept; and

FIG. 9 is a block diagram of the processor illustrated in FIG. 1 according to an exemplary embodiment of the present inventive concept.

### DETAILED DESCRIPTION OF THE EXEMPLARY EMBODIMENTS

Exemplary embodiments of the present inventive concept will be described more fully hereinafter with reference to the accompanying drawings. Like reference numerals may refer to like elements throughout the accompanying drawings.

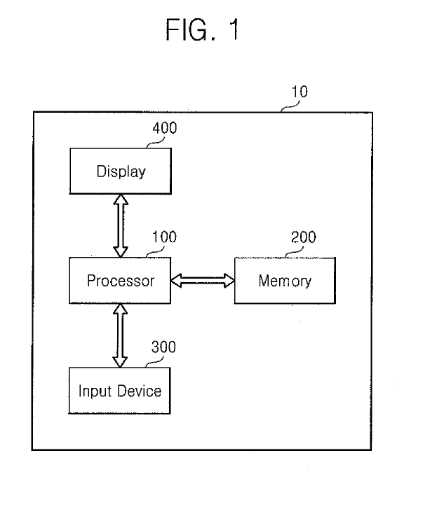

FIG. 1 is a block diagram of an electronic device according to an exemplary embodiment of the present inventive concept. Referring to FIG. 1, an electronic device 10 includes a processor 100, a memory 200, an input device 300 and a display 400, which communicate with each other through a bus.

The processor 100 controls an operation of the electronic device 10. The processor 100 is a unit capable of reading and executing program instructions. According to an exemplary embodiment, the processor 100 may be an application processor. For example, the processor 100 may execute program instructions, e.g., program instructions generated by an input signal input through the input device 300, read data stored in the memory 200, and display read data through the display 400.

The memory 200 may be a non-volatile memory such as a flash memory or a resistive memory, a tape, a magnetic disk, an optical disk, or a solid state drive (SSD), however the memory 200 is not limited thereto. The input device 300 may be, for example, a pointing device such as a touch pad or a computer mouse, or a keypad or a keyboard.

The electronic device 10 may be, for example, a personal computer (PC) or a portable device. The portable device may be, for example, a handheld device such as a laptop computer, a cellular phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, or an e-book.

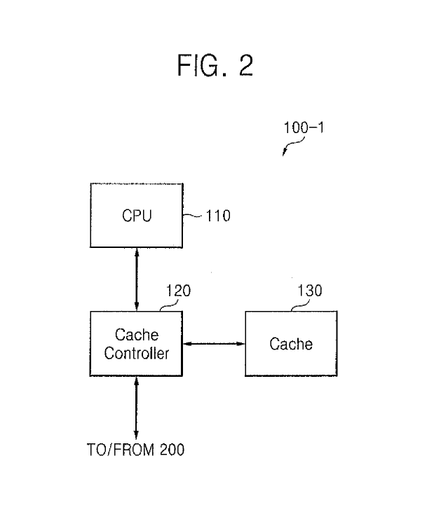

FIG. 2 is a block diagram of the processor illustrated in FIG. 1 according to an exemplary embodiment. Referring to FIGS. 1 and 2, a processor 100-1 includes a central processing unit (CPU) 110, a cache controller 120 and a cache 130. According to an exemplary embodiment, the processor 100-1 may be a chip, e.g., a system on chip (SoC).

The CPU 110 is capable of reading and executing program instructions. When the CPU 110 reads data, the cache controller 120 first checks whether data to be read is stored in the cache 130, since the time taken to read data stored in the cache 130 is shorter than the time taken to read data stored in the memory 200.

When the cache controller 120 does not find data in the cache 130, e.g., when a cache miss occurs, the cache controller 120 may read the data from the memory 200. The cache controller 120 then outputs data read from the memory 200 to the CPU 110, and writes the data in the cache 130. When the CPU 110 reads the same data again, the time taken to read the data may be reduced by reading the data from the cache 130.

For convenience of explanation, writing or replacing data, e.g., erasing stored data and writing new data, is inclusively defined as writing herein.

The cache controller 120 may determine an entry to write data into based on a quality of service (QoS) value of a process output from the CPU 110. The QoS value may be different for each process according to a data processing speed required for the stable operation of a process.

According to an exemplary embodiment, the cache controller 120 may allocate more entries to write the data into when a process executed in the CPU 110 is a process requiring a fast processing speed, e.g., when a QoS value is high, and allocate less entries to write the data into when a process executed in the CPU 110 is a process that requires a relatively slower processing speed, e.g., when a QoS value is low. That is, the number of total entries of the cache controller 120 is allocated to processes executed in the CPU 110 based on the QoS values of the processes.

The cache controller 120 determines an entry list corresponding to a QoS value received from the CPU 110 for which data corresponding to a received process is to be written to, e.g., a replaceable entry list, and writes data in an entry included in the entry list.

When data is stored in all entries included in an entry list, the cache controller 120 removes data stored in an entry among entries included in the entry list and writes, e.g., replaces, the removed data with new data. Accordingly, the entry list may be referred to as a replaceable entry list.

For example, when writing data in the cache 130, the cache controller 120 may write the data in an entry among the remaining entries that currently allocated entries for the QoS value are excluded from (the entry written to is in a replaceable entry list corresponding to a QoS value of a process received from the CPU 110).

The cache controller 120 may replace data stored in one of entries included in the replaceable entry list when data is stored in all entries included in the replaceable entry list.

In addition, when the CPU 110 intends to store new data, the cache controller 120 may store the data in the cache 130 and the memory 200. The process of storing the new data in the cache 130 by the cache controller 120 may be the same as the process of storing data read from the memory 200 in the cache 130 by the cache controller 120 when a cache miss occurs.

According to an exemplary embodiment, the cache controller 120 may fix the number of maximum allocatable entries for each of the QoS values. When a cache miss occurs, the cache controller 120 may compare the number of currently allocated entries with the number of maximum allocatable entries for a QoS value of a process.

Based on the result of the comparison, when the number of currently allocated entries is less than the number of maximum allocatable entries, the cache controller 120 may allocate new entries for the QoS value of the process and update a list of currently allocated entries. When the number of currently allocated entries is not less than the number of maximum allocatable entries, the cache controller 120 may replace one of the currently allocated entries.

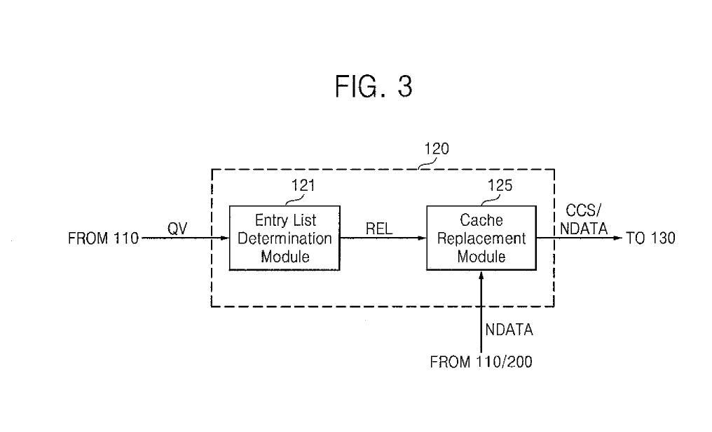

FIG. 3 is a block diagram of the cache controller illustrated in FIG. 2 according to an exemplary embodiment. Referring to FIGS. 1 through 3, the cache controller 120 includes an entry list determination module 121 and a cache replacement module 125.

The term module, as used herein, may refer to hardware configured to perform certain functions and operations according to exemplary embodiments of the present inventive concept, a computer program code configured to perform specific functions and operations, or an electronic recording medium including a computer program code which may execute specific functions and operations. That is, a module may refer to a functional and/or structural combination of hardware for executing a technical concept of the present inventive concept, and/or software for driving the hardware.

The entry list determination module 121 receives a QoS value QV of a process from the CPU 110, and outputs a replaceable entry list REL including replaceable entries corresponding to the received QoS value QV to the cache replacement module 125.

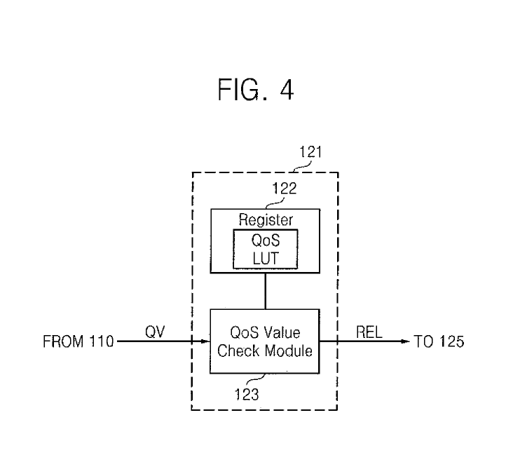

FIG. 4 is a block diagram of the entry list determination module illustrated in FIG. 3 according to an exemplary embodiment. Referring to FIGS. 1 through 4, the entry list determination module 121 includes a QoS look-up table 122 and a QoS value check module 123.

The QoS look-up table 122 stores entry lists corresponding to each of a plurality of QoS values. The QoS look-up table 122 may be, for example, a register. According to an exemplary embodiment, at least two of the stored entry lists may include at least one identical entry. According to an exemplary embodiment, each of the entry lists may include a different entry.

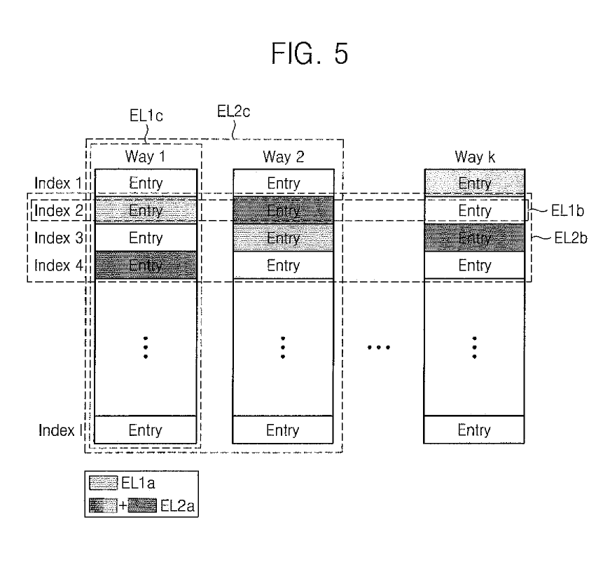

FIG. 5 is a conceptual diagram illustrating a method of setting an entry list corresponding to each of a plurality of QoS values according to an exemplary embodiment. Referring to FIG. 5, at least two of the entry lists may include at least one identical entry. For example, an entry list corresponding to a high QoS value may include an entry included in an entry list corresponding to a low QoS value.

As an example, when each of the entry lists includes at least one entry corresponding to each of the QoS values, a first entry list EL1a may include a second entry list EL2a as illustrated in FIG. 5. As another example, when each of the entry lists includes at least one cache index corresponding to each of the QoS values, a first entry list EL1b may include a second entry list EL2b as illustrated in FIG. 5. As another example, when each of the entry lists includes at least one cache way corresponding to each of the QoS values, a first entry list EL1c may include a second entry list EL2c as illustrated in FIG. 5.

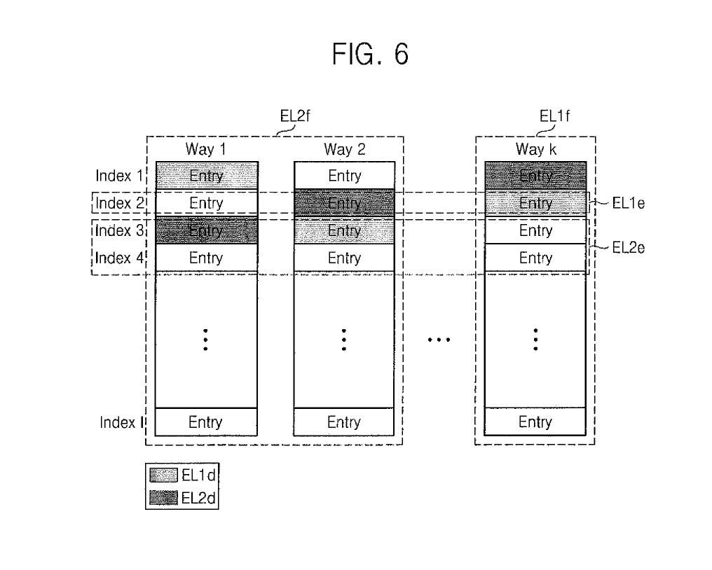

FIG. 6 is a conceptual diagram illustrating a method of setting an entry list corresponding to each of a plurality of QoS values according to an exemplary embodiment. Referring to FIG. 6, each of the entry lists may include a different entry. For example, entries of the cache 130 may be divided into a plurality of groups, and each of the divided groups may be allocated to correspond to each of the QoS values.

As an example, when each of the entry lists includes at least one entry corresponding to each of the QoS values, a first entry list EL1d and a second entry list EL2d may include a different entry as illustrated in FIG. 6. As another example, when each of the entry lists includes at least one cache index corresponding to each of the QoS values, a first entry list EL1e and a second entry list EL2e may include a different entry as illustrated in FIG. 6. As another example, when each of the entry lists includes at least one cache way corresponding to each of the QoS values, a first entry list EL1f and a second entry list EL2f may include a different entry as illustrated in FIG. 6.

Referring to FIGS. 1 through 4, the QoS value check module 123 receives a QoS value QV of a process from the CPU 110 and reads an entry list corresponding to the QoS value QV received from the QoS look-up table 122. The QoS value check module 123 outputs the read entry list to the cache replacement module 125 as a replaceable entry list REL.

The cache replacement module 125 writes data NDATA received from the CPU 110 or the memory 200 in an entry CCS included in a replaceable entry list REL received from the entry list determination module 121.

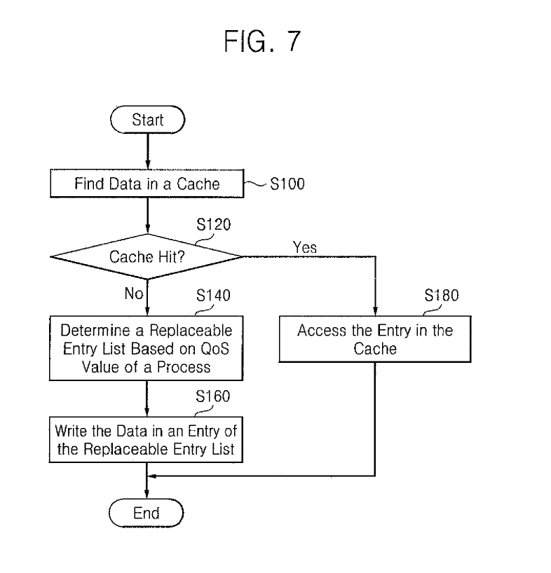

FIG. 7 is a flowchart illustrating a method of controlling a cache memory according to an exemplary embodiment. Referring to FIGS. 1, 2 and 7, when the CPU 110 reads data, the cache controller 120 finds the data within the cache 130 using an address of the data (S100).

A cache miss occurs when the cache controller 120 does not find data in the cache 130. A cache hit occurs when the cache controller 120 finds the data in the cache 130.

At block S120, it is determined whether a cache miss or a cache hit occurs. When a cache miss occurs (NO branch of S120), the cache controller 120 reads data from the memory 200 and outputs the read data to the CPU 110.

For example, when a cache miss occurs, the cache controller 120 determines a replaceable entry list REL based on a QoS value QV of a process received from the CPU 110 (S140), and writes the data in one of the entries included in the replaceable entry list REL (S160). According to an exemplary embodiment, the cache controller 120 may compare the number of currently allocated entries for a QoS value QV with the total number of entries included in the replaceable entry list REL.

Based on the result of the comparison, when the number of the currently allocated entries is less than the total number of entries, the cache controller 120 may write the data in an entry among the total number of entries other than the currently allocated entries (e.g., the data may be written in an empty entry). When the number of the currently allocated entries is not less than the total number of entries, the cache controller 120 may replace one of the currently allocated entries.

When a cache hit occurs (YES branch of S120), the cache controller 120 reads data from the cache 130 and outputs the read data to the CPU 110 (S180).

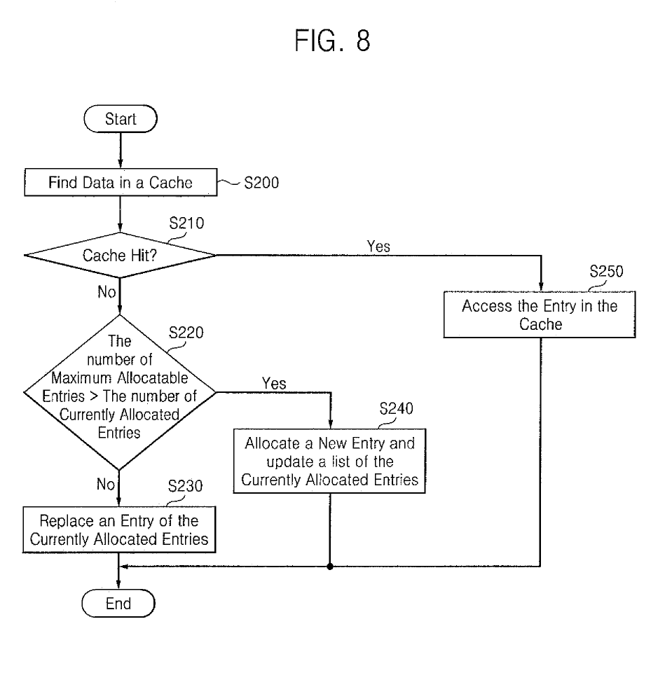

FIG. 8 is a flowchart illustrating a method of controlling the cache memory according to an exemplary embodiment. Referring to FIGS. 1, 2 and 8, when the CPU 110 reads data, the cache controller 120 attempts to find the data in the cache 130 using an address of the data (S200).

A cache miss occurs when the cache controller 120 does not find the data in the 2.5 cache 130. A cache hit occurs when the cache controller 120 finds the data in the cache 130. When a cache miss occurs (NO branch of S210), the cache controller 120 reads the data from the memory 200 and outputs the read data to the CPU 110.

At block S220, the cache controller 120 compares the number of currently allocated entries with the number of maximum allocatable entries for a QoS value QV of a process received from the CPU 110.

Based on the result of the comparison, when a cache miss occurs and the number of the currently allocated entries is not less than the number of maximum allocatable entries, the cache controller 120 replaces one of the currently allocated entries at block S230 (e.g., existing data stored in an entry is erased, and the new data is written in the entry).

Based on the result of the comparison, when a cache miss occurs and the number of the currently allocated entries is less than the number of the maximum allocatable entries, the cache controller 120 allocates a new entry for a QoS value QV of a process and writes data in an allocated new entry at block S240. Here, the cache controller 120 may update a list of currently allocated entries.

When a cache hit occurs (YES branch of S210), the cache controller 120 reads data from the cache 130 and outputs read data to the CPU 110 (S250).

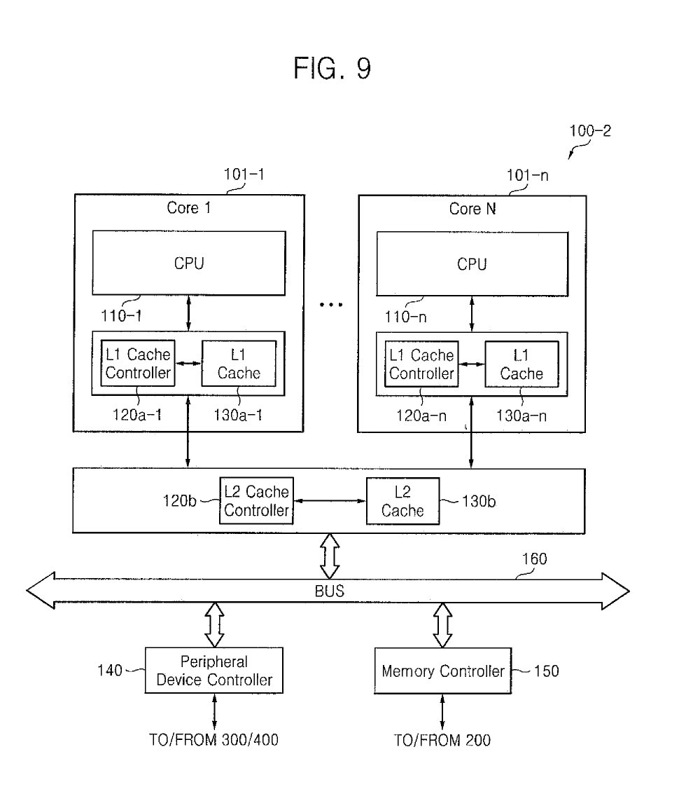

FIG. 9 is a block diagram of the processor shown in FIG. 1 according to an exemplary embodiment. Referring to FIGS. 1 and 9, a processor 100-2 may be a multi-core processor including multi-level caches.

The processor 100-2 includes a plurality of CPU cores 101-1 to 101-n, an L2 cache controller 120b, an L2 cache 130b, a peripheral device controller 140, and a memory controller 150. Each of the L2 cache controller 120b, the peripheral device controller 140 and the memory controller 150 may transmit or receive data or instructions through a system bus 160.

Each CPU core 101-1 to 101-n (generally referred to as 101) includes a CPU 110-1 to 110-n, an L1 cache controller 120a-1 to 120a-n (generally referred to as 120a), and an L1 cache 130a-1 to 130a-n (generally referred to as 130a). When the L1 cache 130a is a level 1 cache, the L2 cache 130b may be a level 2 cache. The L1 cache 130a may include an instruction cache and a data cache. The L2 cache 130b may be, for example, a volatile memory device (e.g., a static random access memory (SRAM)).

Each of the L1 cache controller 120a and the L2 cache controller 120b may be embodied as the cache controller 120 illustrated in FIG. 2. When the L1 cache controller 120a is embodied a the cache controller 120, the CPU 110 of FIG. 2 may correspond to the CPU 110-1 to 110-n illustrated in FIG. 9, and the cache 130 of FIG. 2 may correspond to the L1 cache 130a illustrated in FIG. 9.

When the L2 cache controller 120b is embodied as the cache controller 120, the CPU 110 of FIG. 2 may correspond to the cache controller 120a illustrated in FIG. 9, and the cache 130 of FIG. 2 may correspond to the L2 cache 130b illustrated in FIG. 9.

When the CPU 110 reads data, the L1 cache controller 120a first checks the L1 cache 130a to determine whether data to be read is stored in the L1 cache 130a. This is done since the time taken to read data stored in the L1 cache 130a is shorter than the time taken to read data stored in the memory 200.

When the L1 cache controller 120a finds data from the L1 cache 130a (e.g., when a cache hit occurs), the L1 cache controller 120a outputs data read from the L1 cache 130a to the CPU core 101. However, when the L1 cache controller 120a does not find data from the L1 cache 130a (e.g., when a cache miss occurs), the CPU 110 checks the L2 cache 130b through the L2 cache controller 120b to determine whether the data is stored in the L2 cache 130b.

When the L2 cache controller 120b finds data in the L2 cache 130b (e.g., when a cache hit occurs), the L2 cache controller 120b outputs the data read from the L2 cache 130b to the CPU core 101 through the L1 cache controller 120a. The L1 cache controller 120a may write data read from the L2 cache 130b in the L1 cache 130a.

When the L2 cache controller 120b does not find data in the L2 cache 130b (e.g., when a cache miss occurs), the L2 cache controller 120b reads the data from the memory 200 through the memory controller 150. The L2 cache controller 120b may output data read from the memory 200 to the CPU core 101 through the L1 cache controller 120a, and write the data in the L2 cache 130b.

Accordingly, when the CPU 110 reads the data again, the time taken to read the data may be reduced by reading the data from the L1 cache 130a or the L2 cache 130b.

Each of the L1 cache controller 120a and the L2 cache controller 120b may determine an entry list to write data into based on a QoS value of a process output from the CPU 110-1 to 110-n.

According to an exemplary embodiment, each of the L1 cache controller 120a and the L2 cache controller 120b may allocate more entries to write the data into when a process executed in the CPU 110-1 to 110-n is a process requiring a fast processing speed (e.g., when a QoS value is high), and may allocate less entries to write the data into when a process executed in the CPU 110-1 to 110-n is a process that requires a relatively slower processing speed (e.g., when a QoS value is low).

Each of the L1 cache controller 120a and the L2 cache controller 120b determines an entry list corresponding to a QoS value QV received from the CPU 110-1 to 110-n (e.g., a replaceable entry list), and writes data in an entry included in the entry list. In addition, when the CPU 110-1 to 110-n intends to store new data, each of the L1 cache controller 120a and the L2 cache controller 120b may store the data in the L1 cache 130a, the L2 cache 130b, and the memory 200.

In an exemplary embodiment, a process of storing the new data in an L1 cache 130a or an L2 cache 130b by each of the L1 cache controller 120a and the L2 cache controller 120b is the same as a process of storing data read from the L2 cache 130b or the memory 200 in the L1 cache 130a, the L2 cache 130b, and the memory 200 by each of the L1 cache controller 120a and the L2 cache controller 120b when a cache miss occurs.

According to an exemplary embodiment, the processor 100-2 may be, for example, a system on chip (SoC).

The peripheral device controller 140 may communicate with the input device 300, and may control data processed by the CPU cores 101-1 to 101-n to be displayed on the display 400. The peripheral device controller 140 may include an audio interface, a storage interface such as, for example, an advanced technology attachment (ATA) interface, and/or a connectivity interface.

A QoS based cache controller according to exemplary embodiments of the present inventive concept, and a method of operating the same, may increase a cache hit ratio and improve performance between a plurality of processors.

While the present inventive concept has been particularly shown and described with reference to the exemplary embodiments thereof, it will be understood by those of ordinary skill in the art that various changes in form and detail may be made therein without departing from the spirit and scope of the present inventive concept as defined by the following claims.

What is claimed is:

1. A cache controller, comprising:
an entry list determination module configured to receive a quality of service (QoS) value of a process, and output a replaceable entry list based on the received QoS value; and
a cache replacement module configured to write data in an entry included in the replaceable entry list,
wherein the process is one of a plurality of processes, each having a QoS value, and the replaceable entry list is one of a plurality of replaceable entry lists, each including a plurality of entries and each corresponding to one of the QoS values,
wherein a number of total entries is allocated to processes of the plurality of processes based on the QoS values of the processes.

2. The cache controller of claim 1, wherein the entry list determination module comprises:
a QoS look-up table configured to store the plurality of replaceable entry lists; and
a QoS value check module configured to receive the received QoS value, read a replaceable entry list corresponding to the received QoS value from among the plurality of replaceable entry lists from the QoS look-up table, and output the read replaceable entry list.

3. The cache controller of claim 2, wherein the QoS look-up table is a register.

4. The cache controller of claim 2, wherein at least two of the replaceable entry lists include at least one identical entry.

5. The cache controller of claim 2, wherein each of the replaceable entry lists includes a different entry.

6. The cache controller of claim 2, wherein each of the replaceable entry lists includes at least one cache index corresponding to each of the QoS values.

7. The cache controller of claim 2, wherein each of the replaceable entry lists includes at least one cache way corresponding to each of the QoS values.

8. The cache controller of claim 1, wherein the cache controller is a level one (L1) cache controller or a level 2 (L2) cache controller.

9. The cache controller of claim 1, wherein a greater number of the total entries is allocated to a first process of the plurality of processes having a first QoS value than to a second process of the plurality of processes having a second QoS value lower than the first QoS value.

10. A processor, comprising:
the cache controller of claim 1;
a CPU core; and
a cache memory including the plurality of replaceable entry lists.

11. An electronic device, comprising:
the processor of claim 10; and
a display configured to display data processed by the processor.

12. A cache controller, comprising:
an entry list determination module comprising a quality of service (QoS) look-up table configured to store a plurality of replaceable entry lists.
wherein each of the plurality of replaceable entry lists includes a plurality of entries and corresponds to a different QoS value, each QoS value corresponds to a different process, and a number of total entries is allocated to the processes based on the QoS values of the processes.

13. The cache controller of claim 12, wherein a greater number of the total entries is allocated to a first process having a first QoS value than to a second process having a second QoS value lower than the first QoS value.

14. The cache controller of claim 12, further comprising:
a cache replacement module configured to write data in an entry included in one of the plurality of replaceable entry lists.

15. The cache controller of claim 12, wherein the QoS look-up table is a register.

16. A method of operating a cache controller, comprising:
searching for data in a cache;
determining a replaceable entry list based on a received quality of service (QoS) value of a process upon an occurrence of a cache miss; and
writing the data in an entry included in the replaceable entry list,
wherein the process is one of a plurality of processes, each having a QoS value, and the replaceable entry list is one of a plurality of replaceable entry lists, each including a plurality of entries and each corresponding to one of the QoS values,
wherein a number of total entries is allocated to processes of the plurality of processes based on the QoS values of the processes.

17. The method of claim 16, wherein determining the replaceable entry list comprises reading the replaceable entry list from a QoS look-up table,
wherein the replaceable entry list corresponds to the received QoS value, and the QoS look-up table stores the plurality of replaceable entry lists.

18. The method of claim 17, wherein each of the plurality of replaceable entry lists includes at least one cache index corresponding to each of the QoS values.

19. The method of claim 17, wherein each of the plurality of replaceable entry lists includes at least one cache way corresponding to each of the QoS values.

20. The method of claim 16, wherein writing the data comprises:
comparing a number of currently allocated entries for the received QoS value with a maximum number of allocatable entries included in the replaceable entry list;
writing the data in an entry other than the currently allocated entries upon determining that the number of currently allocated entries is less than the maximum number of allocatable entries based on a comparison result; and
replacing one of the currently allocated entries with the data upon determining that the number of currently allocated entries is not less than the maximum number of allocatable entries based on the comparison result.
